(19) United States
(12) Patent Application Publication
(10) Pub. No.: US 2026/0119026 A1
(43) Pub. Date: Apr. 30, 2026

(54) FLUID SCALE BAR RULER FOR USE WITH A MAP

(71) Applicant: Kevin B. BOYTER, Glen Ellyn, IL (US)

(72) Inventor: Kevin B. BOYTER, Glen Ellyn, IL (US)

(21) Appl. No.: 18/929,212

(22) Filed: Oct. 28, 2024

(51) Int. Cl. G01C 21/36; G06F 3/0486; G06F 3/0488

(52) U.S. Cl. CPC G01C 21/367; G01C 21/3664; G06F 3/0486; G06F 3/0488

(57) ABSTRACT

This invention relates to a fluid scale bar ruler for use with a map that allows a user to drag the fluid scale bar ruler to a first point and a second point to estimate the measurement between the two points without the need to leave the original screen. The fluid scale bar ruler can be pinched out to expand the length of the fluid scale bar ruler to estimate the measurement. The fluid scale bar ruler for use with a map can estimate the measurement between two points in any direction in two-dimensional or three-dimensional directions. A method of using the fluid scale bar ruler for use with a map has the user placing the first end on a first point and the second end on a second point, and estimating the measurement between the two points.

This invention relates to a fluid scale bar ruler for use with a map, and more particularly, to a fluid scale bar ruler for use with a map in which the user can move the fluid scale bar ruler for use with a map from its original position to measure or estimate between two points, expand or contract it, and reposition it in a resting position without the need to leave the original screen.

### BACKGROUND OF THE INVENTION

Maps on electronic devices such as, but not limited to, cellular phones, tablets, augmented reality, visual plane, and laptop and desktop computers (hereinafter “electronic devices”) are commonly used. Maps are used for, among other things, calculating the distance or travel time between two specific points on a map. Most maps have a scale bar which is a measuring tool that can measure the size of features on the map or distance between two points.

However, most scale bars are stationary and found on or near an edge of a map. These scale bars require the user to make an estimate of the size or distance by commonly using their fingers, or other measuring devices, to measure the scale bar and then taking that measurement made with their fingers, or other measuring devices, to the points on the map that need to be measured. This can be cumbersome and inaccurate as the user has to keep the spacing between their fingers, or other measuring devices, constant and may need to make multiple individual measurements using their fingers, or other measuring devices, to measure greater distances between two points. A fluid scale bar ruler for use with a map will be a useful invention.

Also, some scale bars are fixed in size. This means that a user commonly has to use their fingers, as discussed above, or other measuring devices to estimate the size of features or the distance between two points. This can be cumbersome and inaccurate. A fluid scale bar ruler that can expand and contract to measure the size of features or distance between two points on a map will be a useful invention.

Some scale bars or rulers of the prior art, require the user to leave the original screen to another screen or use a drop-down menu to access the bar or ruler. This can require multiple clicks through multiple screens to access the scale bar or ruler which can be cumbersome and awkward. A fluid scale bar ruler for use with a map that is accessible on the original screen without the need to leave the original screen or use a drop-down menu will be a useful invention.

### SUMMARY OF THE INVENTION

Among the objectives of the present invention is the provision of a fluid scale bar ruler for use with a map that is fluid and can be moved around the surface of the map in any two-dimensional or three-dimensional direction.

Moreover, an objective of the present invention is the provision of a fluid scale bar ruler for use with a map that can be expanded to measure the size or distance between two points and then, contracted to be unobstructive when not in use.

A further objective of the present invention is the provision of a fluid scale bar ruler for use with a map that remains on the same screen as the map and can be used without navigating to additional screens or through drop down menus.

A method of using a fluid scale bar ruler for use with a map is also disclosed.

Other objectives and advantages of the invention will become apparent from the description of the preferred embodiments herein.

### BRIEF DESCRIPTION OF THE DRAWINGS

FIG. 1 depicts fluid scale bar ruler for use with a map 100 in resting position 130 on map 102.

FIG. 2 depicts fluid scale bar ruler for use with a map 100 in use in contracted position 132.

FIG. 3 depicts fluid scale bar ruler for use with a map 100 in expanded position 134.

FIG. 4 depicts fluid scale bar ruler for use with a map 100 moving from second point 142 to third point 144.

FIG. 5 depicts fluid scale bar ruler for use with a map 100 in expanded position 134 and using a three-dimensional map 102.

FIG. 6a depicts fluid scale bar ruler for use with a map 100 moving from resting position 130 to use position 128.

FIG. 6b depicts fluid scale bar ruler for use with a map 100 moving from use position 128 to resting position 130.

FIG. 7 depicts a block diagram of electronic device 104.

FIG. 8 depicts a block diagram of method 200 of this invention.

Throughout the figures of the drawings, where the same part appears in more than one figure of the drawings, the same number is applied thereto.

### BRIEF DESCRIPTION OF THE PREFERRED EMBODIMENTS

Reference will now be made in detail to several embodiments of the invention that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, down, over, above, below, beneath, rear, and front, can be used with respect to the drawings. These and similar directional terms are not to be construed to limit the scope of the invention in any manner. The words attach, connect, couple, and similar terms with their inflectional morphemes do not necessarily denote direct or intermediate connections, but can also include connections through mediate elements or devices.

Throughout the disclosure, the term electronic device is used. An electronic device can be any suitable electronic device for running software that creates the map and the fluid scale bar ruler for use with a map of this invention. Electronic devices can be, but are not limited to, a smart phone, a tablet, a laptop computer, a desktop computer, augmented reality, visual plane, or a global positioning system. All such electronic devices that are capable of running the software necessary for this invention are encompassed by this disclosure.

Also, the fluid scale bar ruler for use with a map can be used to measure any physical feature on a map. Such features include, but are not limited to, the distance between two points on the map, the size of features such as, but not limited to, the length and width of rivers, the length, height and width of mountains, or other topography, or the size of manmade features such as, but not limited to, the length, height and width of buildings and monuments or the length, width, and depth of canyons. The fluid scale bar ruler for use with a map can be used to make two-dimensional or three-dimensional measurements. For example, a three-dimensional measurement can be the length, height, and width of a mountain or building or the depth, length, and width of a canyon.

Throughout this disclosure, the term digits and/or input device will be used to describe the user's means of interacting with the fluid scale bar ruler for use with a map of this invention. Digits can mean any or all of the user's fingers or thumbs, or other body parts. Digits can also mean any suitable mechanical apparatus including, but not limited to, a stylus, a keyboard, or a mouse. The digits work with a touch screen 106 to create inputs into electronic device 104. The other input devices 166 may or may not work with a touch screen 106. Any and all suitable devices for the user to interact with the fluid scale bar ruler for use with a map are encompassed by this disclosure.

Also, the digits or other input device can work in a variety of ways. The digits or other input device may drag the first end of the fluid scale bar ruler for use with a map to a first point on the map, be lifted, and have the fluid scale bar ruler for use with a map stay in place at the first point. Then, the second end of the fluid scale bar ruler for use with a map can be positioned by the digits or other input device at the second point on the map and the digits or other input device be lifted and have the fluid scale bar ruler for use with a map stay in place.

Or, the digits or other input device may drag the first end of the fluid scale bar ruler for use with a map to a first point on the map and the user may need to keep their digits or other input device physically touching the screen of the electronic device in order for the fluid scale bar ruler for use with a map to remain in place. Then, the user may need to use another digit or other input device to drag the second end of the fluid scale bar ruler for use with a map to a second point on the map and hold their second digit or input device in place to keep the fluid scale bar ruler for use with a map in position for measuring.

Throughout this disclosure, second end can be placed on second point before first end is placed on first point. Also, the digits, or other input device, can contact the middle (or anywhere between the first end and the second end of the fluid scale bar ruler for use with a map) and position the first end at the first point and the second end at the second point using the middle (or anywhere between the first end and the second end).

The digits or other input device can move the entire fluid scale bar ruler for use with a map to a new measuring position, then, as stated in the two paragraphs above, the digits or other input device can move either of the first end or second end of the fluid scale bar ruler for use with a map into place.

Fluid scale bar ruler for use with a map is described in the disclosure as estimating the measurement between the first point and second point (or additional points) on the map. However, the measurement between the first point and the second point on the map may be accurately measured and this alternative is encompassed by this disclosure.

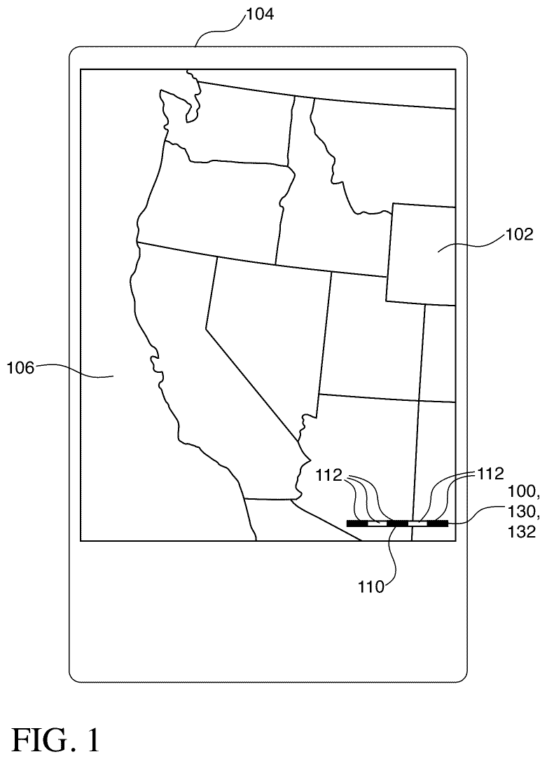

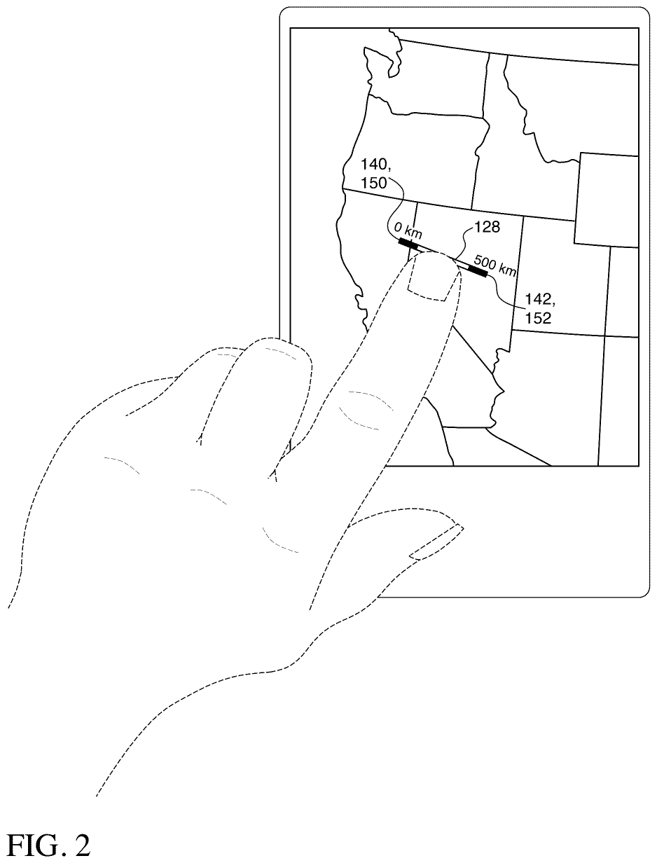

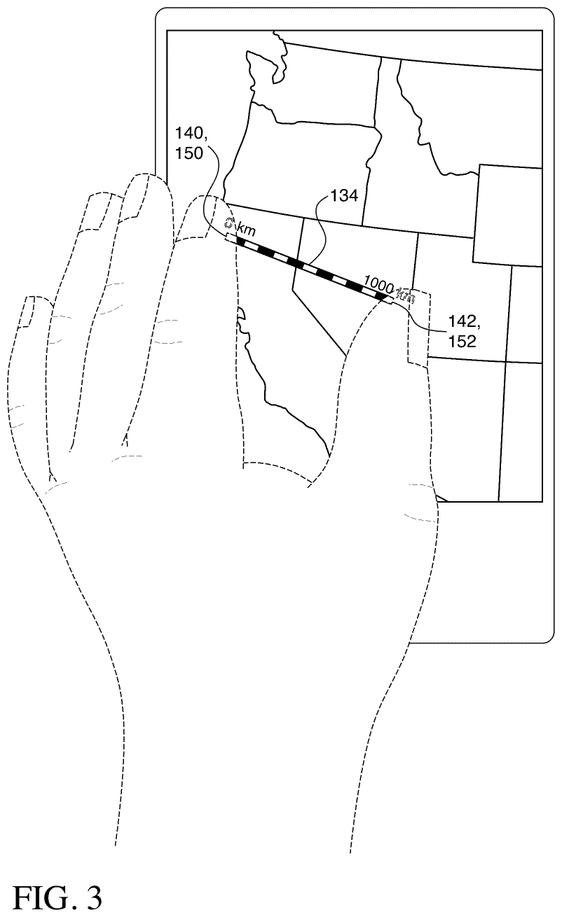

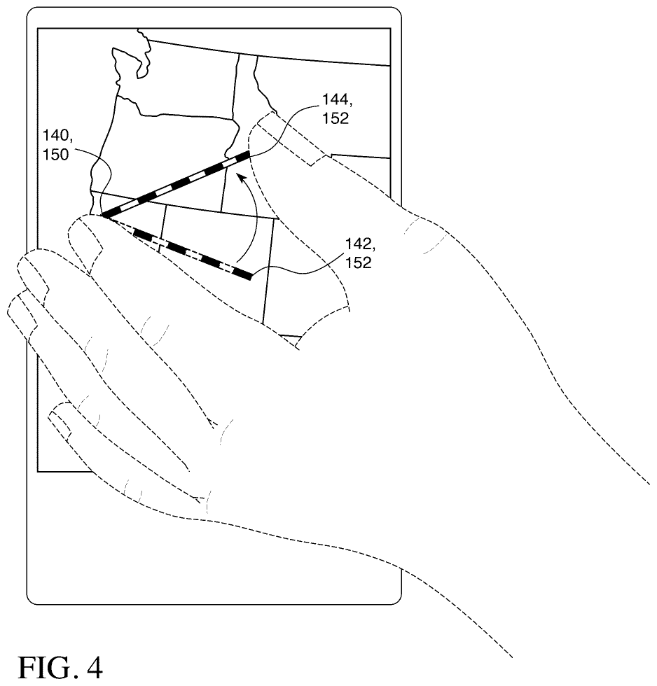

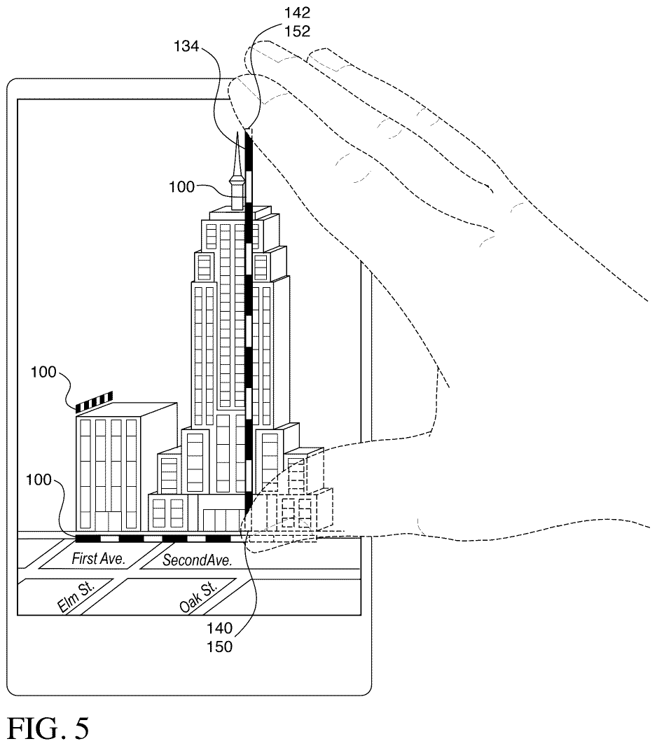

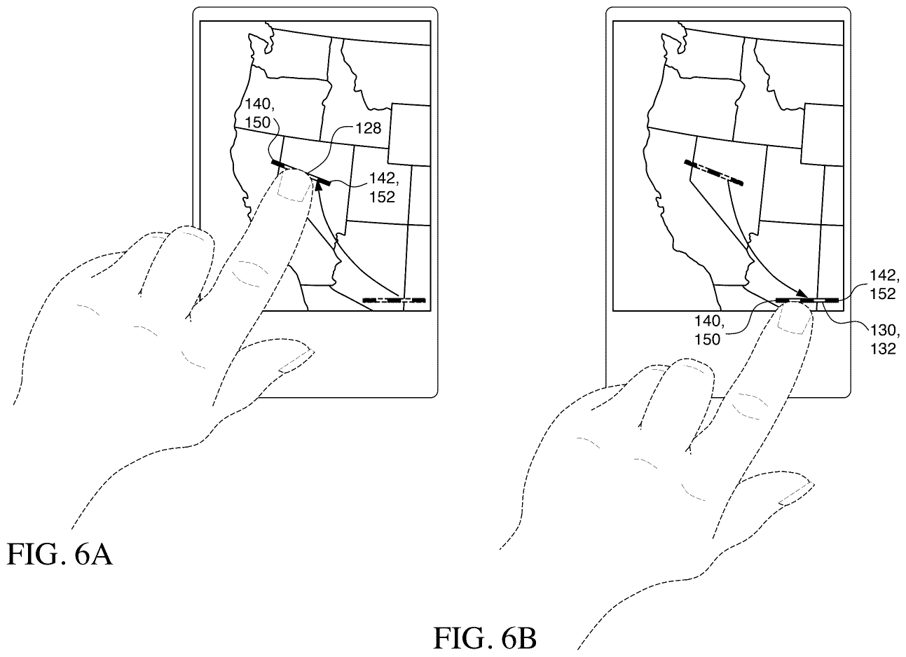

Now adding FIG. 1, FIG. 2, FIG. 3, FIG. 4, FIG. 5, FIG. 6a, and FIG. 6b to the consideration, the fluid scale bar ruler for use with a map 100 (hereinafter “fluid scale bar ruler 100”) can be clearly seen. Electronic device 104 has software to display a map 102 with the fluid scale bar ruler 100. Electronic device 104 may have a global positioning system (hereinafter “GPS”) 162 which can interact with the software for the map 102 and fluid scale bar ruler 100 to allow GPS 162 to detect the user's location and coordinate the user's location on map 102.

Electronic device 104 preferably has a touch screen 106 to interpret inputs from the user's digits or other input device 166 to move fluid scale bar ruler 100 across map 102 from those inputs.

Fluid scale bar ruler 100 is displayed on map 102 on an electronic device 104. Fluid scale bar ruler 100 has base 110 and demarcations 112.

Demarcations 112 are any unit of measurement, including English and metric measurements, and any suitable measurement can be utilized and is encompassed by this disclosure. Measurements can include, but are not limited to, distance, depth, width, length, height or any other suitable measurement and all such measurements are encompassed by this disclosure. The unit of measurement in FIG. 2 and FIG. 3 is kilometers.

As seen in FIG. 2 and FIG. 3, the demarcations 112 for the units of measurement start at original numbers (See FIG. 2 with 0 and 500 kilometers (or “km as depicted in the drawings”)). Then, as fluid scale bar ruler 100 is expanded to expanded position 134, the units of measurement for demarcations 112 increase (See FIG. 3 with 0 and 1,000 kilometers). Fluid scale bar ruler 100 can also be contracted and the units of measurement for demarcations 112 decrease so, for example, in FIG. 2, the units of measurement decrease from 500 kilometers to the estimated distance between the two points being measured. Once estimating is complete, the units of measurement for the demarcations 112 return to their original value. All depicted units of measurement for demarcations 112 are used for example only and are not meant to limit the scope of the invention and any unit of measurement can be used and is encompassed by this disclosure.

Also, FIG. 2 and FIG. 3 only show the last demarcation 112 changing measurement values (500 kilometers to 1,000 kilometers). Each demarcation 112 can change measurement values as well as fluid scale bar ruler 100 expands or contracts.

Fluid scale bar ruler 100 is at resting position 130 and contracted position 132 when not in use and use position 128 when in use. Resting position 130 is preferably at an edge of map 102 so that fluid scale bar ruler 100 does not obstruct or impede viewing of map 102 when fluid scale bar ruler 100 is not in use.

In use, fluid scale bar ruler 100 can be moved or dragged across the surface of map 102 at any angle or position. The user can place a digit, or other input device 166, on screen 106 of electronic device 104. The user can then drag fluid scale bar ruler 100 to the desired portion of map 102 to make the measurement estimations. As stated above, as the fluid scale bar ruler 100 expands or contracts, the units of measurement of demarcations 112 increase or decrease and the final estimated measurement appears on fluid scale bar ruler 100 once it is placed between first point 140 and second point 142 (or additional points).

The user can place first end 150 of fluid scale bar ruler 100 on the first point 140 on map 102. Then, the user places second end 152 of fluid scale bar ruler 100 on the second point 142 on map 102. The first point 140 and the second point 142 are the two points on map 102 that the user wants to estimate the measurement between.

The fluid scale bar ruler 100 can be moved from first point 140 or second point 142 to a third point 144 by moving first end 150 or second end 152 to a third point 144 by dragging, using a digit or other input device 166, the first end 150 or the second end 152 to the third point 144. The measurement between as many points can be measured by dragging, through a digit or other input device 166, first end 150 or second end 152 to different points on map 102, and all such numbers of points are encompassed by this disclosure.

Fluid scale bar ruler 100 can be expanded by pinching out, if necessary, to accommodate for larger measurements between first point 140 and second point 142 (See FIG. 3 and FIG. 5). The fluid scale bar ruler 100 is pinched out until second end 152 reaches the desired second point 142. This pinching out occurs when the distance between the user's two digits or other input device 166 is expanded or made larger which in turn enlarges or expands the length of fluid scale bar ruler 100.

Also, the fluid scale bar 100 can be contracted when the length is too long to measure between the two points (140, 142, 144). If the user overestimates the difference between the two points (140, 142, 144), fluid scale bar ruler 100 can be contracted to correct the error. Or, if the measurement between first point 140 and second point 142 is larger than the measurement between first or second point 140 or 142 and third point 144, the fluid scale bar ruler 100 can be contracted to accommodate for the size difference.

Fluid scale bar ruler 100 is contracted when the measurement between the user's two digits or other input device 166 is shortened or made smaller which in turn shortens or makes smaller the length of the fluid scale bar ruler 100.

Fluid scale bar ruler 100 can estimate the measurement between first point 140 and second point 142 (and any additional points) in a horizontal, vertical, or diagonal angle or direction. Fluid scale bar ruler 100 can also estimate the measurement between first point 140 and second point 142 (and any additional points) in a direction either parallel or perpendicular to the surface of the map 102. And, as can be seen from the figures, fluid scale bar ruler 100 can estimate measurements in two dimensional (See FIG. 2 and FIG. 3) or three dimensional (See FIG. 5). The first end 150 is placed on first point 140. Then, fluid scale bar ruler 100 is rotated so that second end 152 can be placed on second point 142 (See FIG. 2 and FIG. 3).

Once the user is done measuring, the fluid scale bar ruler 100 will return to its contracted and resting positions 130 and 132 either automatically, once the user releases their digits or other input device 166 from the fluid scale bar ruler 10 from first point 140 and second point 142 (or other points), or by the user placing it there through their digits or other input device 166.

Fluid scale bar ruler 100 is accessible on the original screen 106 of map 102. The user positions fluid scale bar ruler 100 by moving their digits or other input device 166 across the surface of the electronic device 104. The user does not have to access additional screens or use a drop-down menu to access and use fluid scale bar ruler 100.

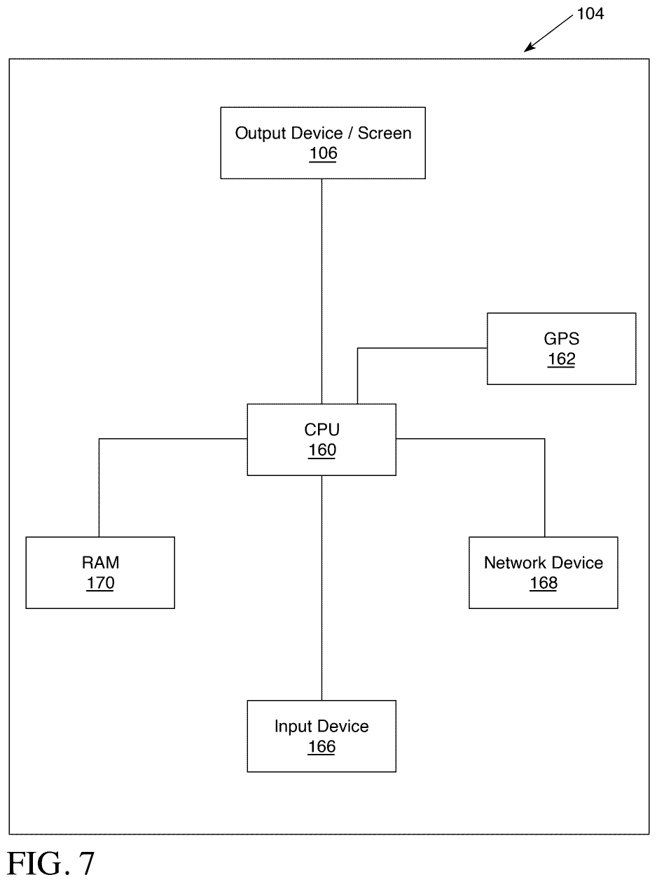

Now adding FIG. 7 to the consideration, an embodiment of the invention incorporated into a cellular phone 104 can be clearly seen. Although what is described is a general-purpose cellular phone, any computer or electronic device, special purpose or general purpose, such as a tablet, desktop, or laptop, can be used so long as it has equivalent functionality and/or equivalent parts with equivalent capabilities.

Electronic device 104 comprises CPU 160, RAM (or hard drive/persistent storage device on other electronic devices 104) 170, GPS 162, Display/Screen 106, Input Device 166, and Network Device 168. A series of instructions is stored on RAM 162 which encode the software for the map 102 and the fluid scale bar ruler 100. CPU 160 causes the instructions to be read into RAM 170 and then executes them, accepting input, through input device 166, from the user regarding the first point 140 and second point 142 (and other points) and displaying the results on Screen/Display 106.

GPS 162 cooperates with the CPU 160 to locate a user's physical position in the real world in relation to the map 102 and displays such position on map 102.

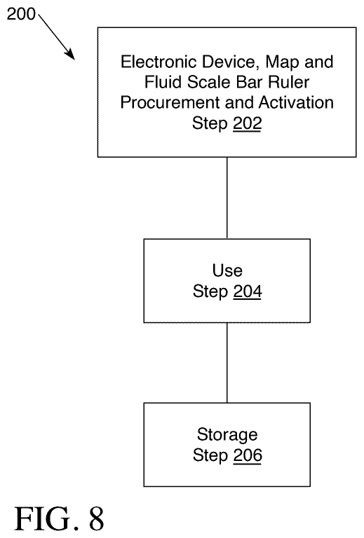

Now adding FIG. 8 to the consideration, method 200 can be clearly seen. Method 200 has the following steps. As will be obvious to persons of ordinary skill in the art, the steps, or steps equivalent thereto, may be practiced in any reasonable order which will produce the desired result.

STEP 202 is the electronic device, map and fluid scale bar ruler procurement and activation step. In this STEP 202, a user obtains and turns on or activates an electronic device 104, and if the software which runs and displays the map with the fluid scale bar ruler 100 is not installed, the software is installed on electronic device 104. The user may already have an electronic device 104 with the software for running and displaying the map with the fluid scale bar ruler 100 installed, and if so, the user can activate or turn on electronic device 104 and proceed to STEP 204.

STEP 204 is the use step. The user activates the software program for map 102 with fluid scale bar ruler 100. The user selects the first point 140 and the second point 142 to estimate the measurement between. The user uses their digits, or other input device, 166 to move first end 150 of fluid scale bar ruler 100 and places first end 150 on first point 140. The user then uses their digits, or other input device, 166 to move second end 152 of fluid scale bar ruler 100 and places second end 152 on second point 142. If necessary, the user pinches out/expands or contracts the distance between their digits, or other input device, 166 across the surface of the screen 106 of electronic device 104 to expand or contract the length of fluid scale bar ruler 100 to allow fluid scale bar ruler 100 to cover the full distance between first point 140 and second point 142. Once the fluid scale bar ruler 100 is placed between first point 140 and second point 142, the unit of measurement between the two points is displayed to give the estimation of measurement.

Once the user has estimated the measurement between first point 140 and second point 142, the user can stop estimating the measurement and either physically slide fluid scale bar ruler 100 back to its resting and contracted positions 130 and 132 or the software program for the fluid scale bar ruler 100 automatically returns the fluid scale bar ruler 100 back to its resting and contracted positions 130 and 132.

Or, the user can select a third point 144 to estimate the measurement between. The user then moves the second end 152 from second point 142 to third point 144. The user may need to use their digits, or other input device, 166 to expand or contract the length of fluid scale bar ruler 100 in order to accommodate the distance between first point 140 and third point 144. Once the fluid scale bar ruler 100 is placed between first point 140 and third point 144 (or other points), the unit of measurement between the two points is displayed to give the estimation of measurement.

In the method described above, to expand the length of fluid scale bar ruler 100 the user expands the distance between their digits, or other input device, 166 across the surface of the map 102. To contract the length of fluid scale bar ruler 100, the user shortens the distance between their digits, or other input device, 166 across the surface of the map 102.

It is noted that the user may choose to estimate the measurement in between second point 142 and third point 144 in addition to or instead of between first point 140 and third point 144. The user can measure between as many points as desired.

STEP 206 is the storage step. In this STEP 206, the software program running the map 102 with fluid scale bar ruler 100 is deactivated.

While various embodiments and aspects of the present invention have been described above, it should be understood that they have been presented by way of example only, and not limitation. Thus, the breadth and scope of the present invention should not be limited by any of the above exemplary embodiments.

This application—taken as a whole with the abstract, specification, claims, and drawings being combined-provides sufficient information for a person having ordinary skill in the art to practice the invention as disclosed herein. Any measures necessary to practice this invention are well within the skill of a person having ordinary skill in this art after that person has made a careful study of this disclosure.

Because of this disclosure and solely because of this disclosure, modification of this device and method can become clear to a person having ordinary skill in this particular art. Such modifications are clearly covered by this disclosure.

What is claimed and sought to be protected by Letters Patent is:

1. A fluid scale bar ruler for use with a map comprising:
a) a fluid scale bar ruler which cooperates with a map;
b) the fluid scale bar ruler being expandable and contractable, wherein the fluid scale bar ruler can be expanded between a first point and a second point for estimating a measurement between the first point and the second point, and contract back to a contracted position once estimating is completed and, further wherein the fluid scale bar ruler can be contracted between the first point and the second point for estimating the measurement between the first point and the second point, and expand back the contracted position once estimating is completed;
c) the fluid scale bar ruler being positionable between the first point and the second point on the map in any two-dimensional or three-dimensional direction, wherein the fluid scale bar ruler is able to estimate a measurement between the first point and the second point in any two-dimension or three-dimensional direction; and
d) the fluid scale bar ruler being accessible without the need to leave an original screen for the map.

2. The fluid scale bar ruler of claim 1 further comprising:
a) the fluid scale bar ruler having a first end and a second end, wherein the first end can be positioned on the first point on the map and the second end can be positioned on the second point on the map to estimate the measurement between the first point and the second point.

3. The fluid scale bar ruler of claim 1 further comprising:
a) the fluid scale bar ruler having at least one demarcation, wherein the at least one demarcation is a unit of measurement.

4. The fluid scale bar ruler of claim 2 further comprising:
a) the fluid scale bar ruler having at least one demarcation, wherein the at least one demarcation is a unit of measurement.

5. The fluid scale bar ruler of claim 1 further comprising:
a) the fluid scale bar ruler having a resting position, wherein the resting position is at an edge of the map so that the fluid scale bar ruler does not obstruct the map when not in use.

6. The fluid scale bar ruler of claim 2 further comprising:
a) the fluid scale bar ruler having a resting position, wherein the resting position is at an edge of the map so that the fluid scale bar ruler does not obstruct the map when not in use.

7. The fluid scale bar ruler of claim 3 further comprising:
a) the fluid scale bar ruler having a resting position, wherein the resting position is at an edge of the map so that the fluid scale bar ruler does not obstruct the map when not in use.

8. The fluid scale bar ruler of claim 4 further comprising:
a) the fluid scale bar ruler having a resting position, wherein the resting position is at an edge of the map so that the fluid scale bar ruler does not obstruct the map when not in use.

9. A method of using a fluid scale bar ruler to estimate the measurement between two points on a map comprising:
a) the fluid scale bar ruler cooperating with a map which is run by a software program on an electronic device;
b) the fluid scale bar ruler being configured to allow the user to move a first end of the fluid scale bar ruler to a first point on the map and the second end of the fluid scale bar ruler to a second point on the map, wherein the fluid scale bar ruler is configured to expand or contract, if necessary, to reach the second point, further wherein the fluid scale bar ruler can be moved to the first point and the second point without the need to leave the original screen containing the map;
c) the user using at least one of a plurality of demarcations on the fluid scale bar ruler to estimate the measurement between the first point and the second point; and
d) the fluid scale bar ruler being configured to return to a resting position once the user releases the input device from the second point.

10. The method of claim 9 further comprising:
a) the fluid scale bar ruler being configured to allow the user, through the input device to move the second end from the second point to a third point.

11. The method of claim 9 further comprising:
a) the fluid scale bar ruler estimating a measurement in a direction perpendicular to a surface of the map.

12. The method of claim 10 further comprising:
a) the fluid scale bar ruler estimating a measurement in a direction perpendicular to a surface of the map.

13. The method of claim 9 further comprising:
a) the fluid scale bar ruler estimating a measurement in a direction parallel to a surface of the map.

14. The method of claim 10 further comprising:
a) the fluid scale bar ruler estimating a measurement in a direction parallel to a surface of the map.

15. The method of claim 9 further comprising:
a) the fluid scale bar ruler estimating a measurement in a direction diagonal to a surface of the map.

16. The method of claim 10 further comprising:
a) the fluid scale bar ruler estimating a measurement in a direction diagonal to a surface of the map.

17. A device for using a fluid scale bar ruler comprising:
a) an electronic device comprising a CPU, a RAM and/or a persistent storage device, an input device, a global positioning system, and a visual display, the RAM and/or the persistent storage device, the global positioning system, the input device, and the visual display operably connected to the CPU;
b) a set of instructions stored on the RAM and/or the persistent storage device which are executed by the CPU and cause the digital computer to perform the following operations;
i) activate a software for a map with the fluid scale bar ruler;
ii) allow the user to move the fluid scale bar ruler to a first position and a second position;
iii) allow the user to estimate a measurement between the first position and the second position; and
iv) return the fluid scale bar ruler to an original position.

18. The device for using a fluid scale bar ruler of claim 18 further comprising:
a) the global positioning system configured to cooperate with the CPU to locate a user's position and display this position on the map; and
b) the fluid scale bar ruler being usable without the need to leave the original screen of the software program running on the electronic device.
